(19) United States
(12) Patent Application Publication
(10) Pub. No.: US 2026/0034797 A1
(43) Pub. Date: Feb. 5, 2026

(54) LIQUID EJECTION HEAD AND LIQUID EJECTION APPARATUS

(71) Applicant: CANON KABUSHIKI KAISHA, Tokyo (JP)

(72) Inventors: HIROKI TAJIMA, Kanagawa (JP); CHIAKI MURAOKA, Saitama (JP); TAKEHO MIYASHITA, Kanagawa (JP); SHIMPEI YOSHIKAWA, Kanagawa (JP); KAZUYA YOSHII, Kanagawa (JP)

(21) Appl. No.: 19/289,766

(22) Filed: Aug. 4, 2025

(30) Foreign Application Priority Data
Aug. 5, 2024 (JP) 2024-129031

(51) Int. Cl. B41J 2/175; B41J 2/18; B41J 2/19

(52) U.S. Cl. CPC B41J 2/17596; B41J 2/18; B41J 2/19

(57) ABSTRACT

A liquid ejection head includes a main body having a first connected portion and a second connected portion, a tank stored within the main body, a first surface provided with a first connecting portion and a second surface provided with a second connecting portion, and a plurality of sealing members interposed between the first connecting portion and the first connected portion and between the second connecting portion and the second connected portion. One of the first connecting portion and the first connected portion is a first protrusion on which the sealing member is externally fitted, the other is a first recess in which the sealing member is internally fitted, one of the second connecting portion and the second connected portion is a second protrusion on which the sealing member is externally fitted, and the other is a second recess in which the sealing member is internally fitted.

### BACKGROUND

### Field of the Technology

The present disclosure relates to a liquid ejection head and a liquid ejection apparatus including the liquid ejection head.

### Description of the Related Art

It is known that, in some conventional liquid ejection apparatuses that record images on a recording medium using a liquid ejection head that ejects a liquid such as ink, a sub-tank member that stores the liquid is provided on the liquid ejection head. When, for example, the liquid ejection head is movable (capable of scanning), the sub tank member moves together with the liquid ejection head and is therefore fixed to the main body of the liquid ejection head.

Japanese Patent Application Publication No. 2022-15694 discloses a liquid ejection apparatus including a liquid ejection head in which a sub-tank member is fixed to the main body with a plurality of screws.

### SUMMARY

When fixing members such as screws or similar fasteners are used to fix the sub-tank member to the main body, an increase in the number of the fixing members may lead to an increase in the time required for the fixing work and in the cost.

The present disclosure is directed to provide a liquid ejection head having improved reliability at a connection portion between a main body and a tank housed inside the main body.

According to an aspect of the present disclosure, a liquid ejection head of the present disclosure includes:
a main body having a first connected portion which is configured to allow liquid to pass therethrough and a second connected portion which is configured to allow liquid to pass therethrough;
a tank stored within the main body, the tank including a liquid storage portion configured to store liquid therein, a first surface provided with a first connecting portion that is connected to the first connected portion and configured to allow liquid to pass therethrough and a second surface provided with a second connecting portion that is connected to the second connected portion and configured to allow liquid to pass therethrough, the second surface being non-parallel to the first surface; and
a plurality of sealing members interposed between the first connecting portion and the first connected portion and between the second connecting portion and the second connected portion,
wherein one of the first connecting portion and the first connected portion is a first protrusion on which the sealing member is externally fitted, and the other is a first recess in which the sealing member is internally fitted, and one of the second connecting portion and the second connected portion is a second protrusion on which the sealing member is externally fitted, and the other is a second recess in which the sealing member is internally fitted.

According to the present disclosure, it is possible to provide a liquid ejection head that has improved reliability at a connection portion between a main body and a tank housed inside the main body.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of the configuration of a liquid ejection apparatus according to an embodiment;

FIG. 2 is a perspective view of the liquid ejection head according to the embodiment;

FIG. 3 is an exploded perspective view of the liquid ejection head according to the embodiment;

FIG. 4 is an exploded perspective view of the liquid ejection head according to the embodiment;

FIG. 5 is a cross-sectional view of the liquid ejection head according to the embodiment;

FIG. 6 is a detailed cross-sectional view of a first connecting portion of the liquid ejection head according to the embodiment;

FIG. 7 is a detailed cross-sectional view of a second connecting portion of the liquid ejection head according to the embodiment;

FIG. 8 is an exploded perspective view of a liquid ejection head according to a comparative example; and

FIG. 9 is an exploded perspective view of the liquid ejection head according to the comparative example.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

Herein, the term “printing” (also referred to as “recording” or “print”) refers not only to the formation of meaningful information such as characters and graphics, but also to the formation of information regardless of whether it is meaningful or not. Furthermore, the term also encompasses cases in which images, patterns, or the like are formed on a recording medium, or the medium is processed, regardless of whether the result is manifested in a form perceptible by human vision.

### Comparative Example

First, prior to the description of embodiments of the present disclosure, the configuration of a liquid ejection head 100 according to a comparative example will be described. The liquid ejection head 100 according to the comparative example is a circulation-type liquid ejection head capable of circulating liquid around an ejection port that ejects the liquid.

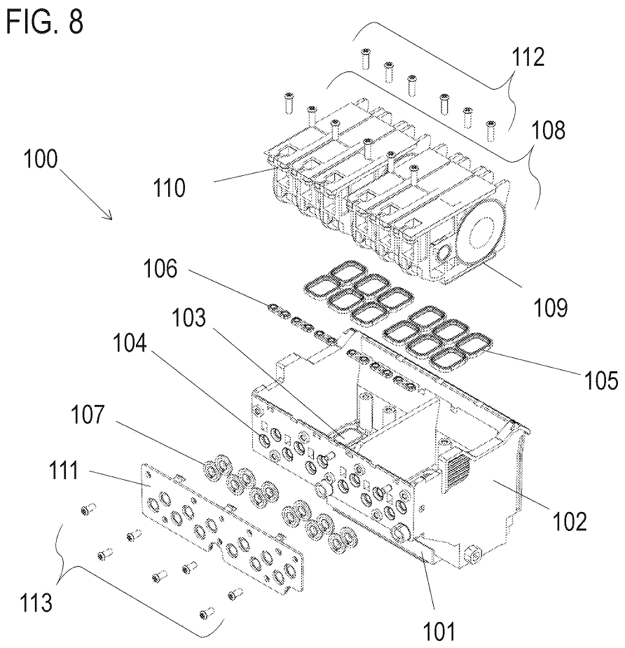

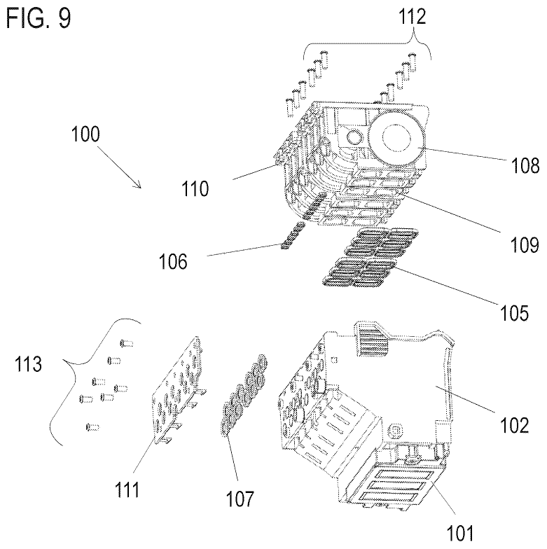

FIGS. 8 and 9 show the configuration of the liquid ejection head 100 according to the comparative example. FIG. 8 is an exploded perspective view of the liquid ejection head 100 according to the comparative example. FIG. 9 is an exploded perspective view of the liquid ejection head 100 according to the comparative example, as viewed from an angle different from that of FIG. 8.

A liquid supply flow path and a liquid recovery flow path are provided in the ejection port array of the liquid ejection head 100, allowing liquid to be circulated through pressure chambers corresponding to the ejection ports. A plurality of sub-tank members, each including a circulation pump, are mounted in the liquid ejection head 100, and the liquid supply flow path and the liquid recovery flow path in the liquid ejection head 100 are formed across the main body and the sub-tank members. According to such a configuration, it is possible, during printing, to suppress the discharge of bubbles in the flow paths and an increase in the viscosity of the liquid in the vicinity of the ejection port and within the flow paths due to moisture evaporation from the ejection port.

A plurality of sub-tank members 108, each corresponding to a different color of ink, are mounted in the liquid ejection head 100. The plurality of sub-tank members 108 are housed inside a housing member 102 that constitutes the main body of the liquid ejection head 100.

A liquid ejection module 101 having a plurality of ejection ports formed therein for ejecting ink is mounted on the housing member 102. The housing member 102 is provided with a first liquid supply portion 103 in communication with the liquid ejection module 101 and a second liquid supply portion 104 for connection with the main body of the liquid ejection apparatus.

The sub-tank member 108 is provided with a first opening 109 connected to the first liquid supply portion 103 and a second opening 110 in communication with the second liquid supply portion 104. A first sealing member 105 is interposed at the connection portion between the first liquid supply portion 103 and the first opening 109. Meanwhile, a second sealing member 106 is interposed at the connection portion between the second liquid supply portion 104 and the second opening 110. The sub-tank member 108 is fastened by a plurality of screws 112 and fixed to the housing member 102.

In the liquid ejection head 100, the sealing surface of the first liquid supply portion 103 and the sealing surface of the second liquid supply portion 104 are not on the same plane in the press-contact direction. In the liquid ejection head 100, dimensional errors due to component tolerances of the housing member 102 and the sub-tank member 108 are likely to occur to some extent. The first liquid supply portion 103 and the second liquid supply portion 104 each achieve sealing by sandwiching a sealing member in the press-contact direction, and therefore it is necessary to ensure a sealing height that can absorb dimensional errors. In such a configuration, some portions are pressed with greater force than others, resulting in uneven contact pressure and leaving little margin in sealing reliability.

The flow path inside the second liquid supply portion 104 is formed to bend at an approximately right angle somewhere along the path. The second liquid supply portion 104 is connected to be in communication with a liquid supply needle provided in the main body of the liquid ejection apparatus. A plate member 111 is fastened with a plurality of screws 113 on the surface of the housing member 102 where the second liquid supply portion 104 opens. A third sealing member 107 is sandwiched between the housing member 102 and the plate member 111 at a portion corresponding to the second liquid supply portion 104. More specifically, one end side of the second liquid supply portion 104 connected to the sub-tank member 108 is sealed by the second sealing member 106, and the other end side of the liquid ejection apparatus connected to the main body is sealed by the third sealing member 107.

When the flow path is formed to bend at a right angle in this way, burrs or the like may be generated at the joint portions of the flow path during molding of the housing member 102. When many types of sealing members, each fixed with screws, are used as in the comparative example, the number of parts increases, which may lead to higher manufacturing costs. Furthermore, the number of man-hours for screw fastening increases, which may lead to an increase in the time required for the fixing work.

### EMBODIMENTS

An embodiment of the present disclosure will now be described with reference to a liquid ejection apparatus 50 that ejects ink as a recording liquid onto a recording medium P such as paper or a sheet to record an image and a liquid ejection head 1 provided in the liquid ejection apparatus 50. Meanwhile, the present disclosure is also applicable to liquid ejection heads that eject liquids other than ink, as well as to other liquid ejection apparatuses.

### Liquid Ejection Apparatus

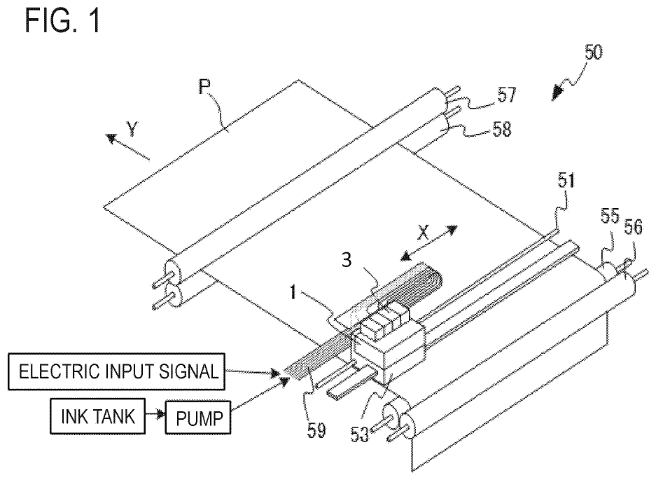

FIG. 1 is a schematic view of the configuration of the liquid ejection apparatus 50 according to the present embodiment. The liquid ejection apparatus 50 includes a liquid ejection head 1. The liquid ejection apparatus 50 of the present embodiment is a serial scan type ink-jet recording apparatus that ejects ink from the liquid ejection head 1 to record an image on a recording medium P. The liquid ejection head 1 is mounted on a carriage 53, and the carriage 53 moves in a main scanning direction X along a guide shaft 51. More specifically, the liquid ejection head 1 is configured to be able to scan (move) in the main scanning direction X with respect to the main body of the liquid ejection apparatus 50.

The liquid ejection apparatus 50 includes a conveyance portion that conveys a recording medium P in a sub-scanning direction Y, which intersects with the main scanning direction X. The conveyance portion includes conveyance members such as conveyance rollers 55, 56, 57, and 58 that convey the recording medium P. In the present embodiment, the main scanning direction X (the moving direction of the liquid ejection head 1) and the sub-scanning direction Y (the conveyance direction of the recording medium P) are orthogonal to each other.

A sub-tank unit 3 is mounted on the liquid ejection head 1, and ink is supplied for each ink. Electrical wirings, ink, and air pipes necessary for printing are connected to the carriage 53 via a guide 59. The sub-tank unit 3 contains inks of multiple colors, and the liquid ejection head 1 is configured to perform high-quality full-color printing using the plurality of color inks.

A cap member (not shown) is disposed at a position offset from the conveyance path of the recording medium P. The cap member relatively moves to a position where it covers the face surface of the liquid ejection head 1 when recording is not performed, to prevent drying of the ejection ports and to perform suction operations for filling or recovery.

### Liquid Ejection Head

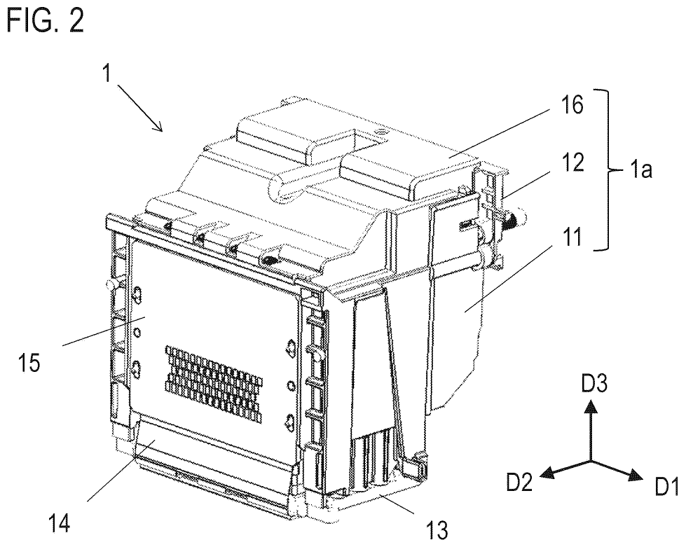

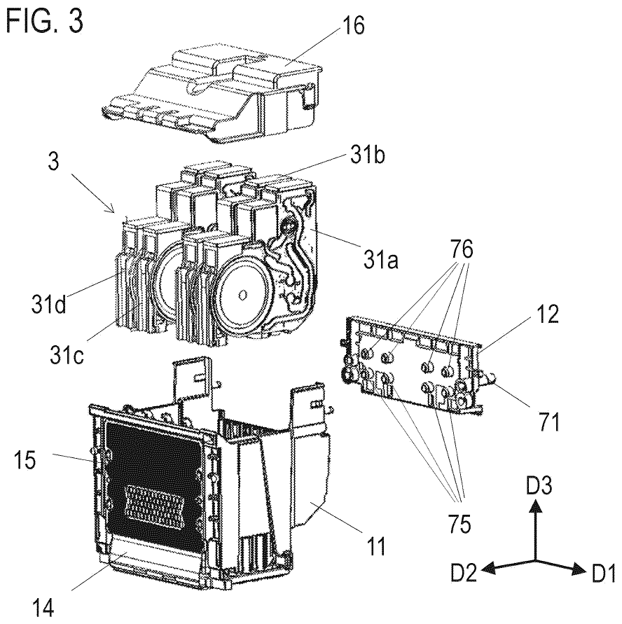

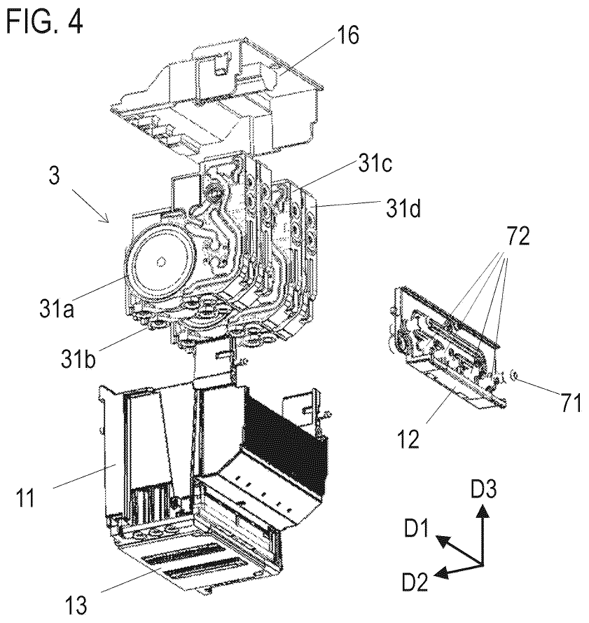

The configuration of the liquid ejection head 1 will be described in detail. FIG. 2 is a perspective view of the liquid ejection head 1 according to the embodiment. FIG. 3 is an exploded perspective view of the liquid ejection head 1. FIG. 4 is an exploded perspective view of the liquid ejection head 1, as viewed from an angle different from that of FIG. 3.

In the following description, the orientation of the liquid ejection head 1 will be described with reference to its mounted state in the liquid ejection apparatus 50. In this case, a direction parallel to the main scanning direction X is defined as a first direction D1, a direction parallel to the sub-scanning direction Y is defined as a second direction D2, and a direction intersecting the first direction D1 and the second direction D2 is defined as a third direction D3. In the embodiment, the first direction D1, the second direction D2, and the third direction D3 are perpendicular to each other. In addition, the third direction D3 is a direction that is substantially parallel to the liquid ejection direction of the liquid ejection head 1.

The liquid ejection head 1 includes the sub-tank unit 3, a housing member 11, a joint member 12, and a head cover 16. The housing member 11, the joint member 12, and the head cover 16 constitute the main body 1a (exterior portion) of the liquid ejection head 1, and the sub-tank unit 3 is stored inside the housing member 11. More specifically, the housing member 11, the joint member 12, and the head cover 16 constitute a tank storage portion for storing the sub-tank unit 3.

The sub-tank unit 3 of the liquid ejection head 1 includes a plurality of sub-tank members 31, each corresponding to a different color of ink. The sub-tank member 31 has a liquid storage portion for storing ink. In the present embodiment, the sub-tank unit 3 includes a circulation unit for circulating liquid. The circulation unit of the present embodiment has a pump for circulating liquid and pressure regulating means for regulating the pressure of the liquid. The circulation unit allows ink to be circulated in the liquid ejection head 1 via the liquid supply flow path and the liquid recovery flow path.

In the present embodiment, the liquid ejection head 1 is provided with four sub-tank members 31. Hereinafter, the sub-tank members 31 will be referred to as sub-tank members 31a, 31b, 31c, and 31d as needed, and simply as the sub-tank member 31 when no distinction is necessary. The sub-tank members 31a, 31b, 31c, and 31d are arranged side by side in this order in the first direction D1.

A liquid ejection module 13 for ejecting (supplying) liquid stored in the sub-tank unit 3 is connected to the housing member 11. The liquid ejection module 13 is provided at a lower part (an end in the third direction D3) of the housing member 11. The liquid ejection module 13 is a liquid ejection member provided with a plurality of ejection ports for ink ejection.

The liquid supply path and the flow recovery path for circulating ink in the liquid ejection head 1 extend from the sub-tank member 31 to the liquid ejection module 13 via the housing member 11. More specifically, ink is supplied to the liquid ejection module 13 from the sub-tank member 31 and then returned to the sub-tank member 31 from the liquid ejection module 13, both via the housing member 11.

The liquid ejection head 1 includes a printed wiring board (hereinafter referred to as “PWB”) 15 and a flexible printed circuit (hereinafter referred to as “FPC”) 14. The PWB 15 and the FPC 14 are electrical connecting members that electrically connect the liquid ejection module 13 and the main body of the liquid ejection apparatus 50. The PWB 15 is fixed to the housing member 11.

The joint member 12 is a connecting member that connects the liquid ejection head 1 to the liquid ejection apparatus 50 so that liquid can be supplied from the main body of the liquid ejection apparatus 50 to the liquid ejection head 1. The joint member 12 is fixed to the housing member 11 with fastening members such as screws or similar fasteners. The joint member 12 is connected to all the sub-tank members 31.

The joint member 12 has a positioning needle 71 that protrudes in the second direction D2 toward the outside of the liquid ejection head 1. The positioning needle 71 serves as a positioning portion for positioning the liquid ejection head 1 with respect to the main body of the apparatus when the liquid ejection head 1 is connected to the main body of the apparatus.

The joint member 12 includes a liquid connection needle 72 for connecting the main body to the flow path, a liquid connection needle 75 for connecting the plurality of sub-tank members 31 to the flow path, a bubble removal needle 76 for removing unnecessary bubbles from the plurality of sub-tank members 31. The liquid connection needle 72 is a liquid connection portion that protrudes in the same direction as the positioning needle 71. The liquid connection needle 75 is a liquid connection portion that protrudes in a direction opposite to the positioning needle 71 and the liquid connection needle 72. The bubble removal needle 76 is a bubble removal portion that protrudes in the same direction as the liquid connection needle 75.

The joint member 12 is provided with four liquid connection needles 72, four liquid connection needles 75, and four bubble removal needles 76 arranged side by side in the first direction D1. The sub-tank members 31a, 31b, 31c, and 31d are each connected to the housing member 11. Each of the sub-tank members 31a, 31b, 31c, and 31d is connected with a liquid connection needle 75 and a bubble removal needle 76 of the joint member 12.

The head cover 16 is a protective member provided at an upper portion (an end in the third direction D3) of the housing member 11 to protect the sub-tank unit 3. The head cover 16 is fixed to the housing member 11.

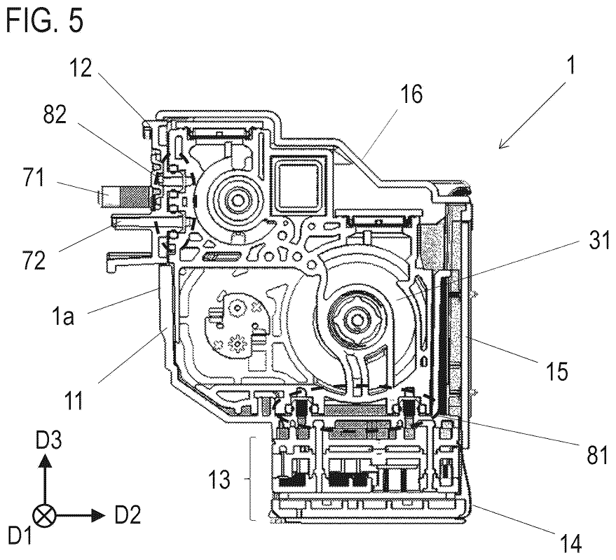

FIG. 5 is a cross-sectional view of the liquid ejection head 1 taken along a section orthogonal to the first direction D1. As described above, the sub-tank member 31 is connected to both the housing member 11 and the joint member 12. Hereinafter, the connection portion between the housing member 11 and the sub-tank member 31 will be described as a first connecting portion 81, and the connection portion between the sub-tank member 31 and the joint member 12 will be described as a second connecting portion 82.

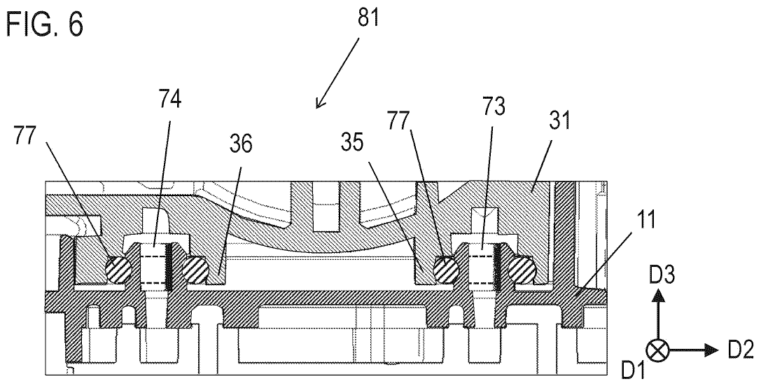

FIG. 6 is an enlarged cross-sectional view showing details of the first connecting portion 81 of the liquid ejection head 1. The sub-tank member 31 has a liquid supply port 35 and a liquid recovery port 36 as a first connecting portion connected to the housing member 11. Meanwhile, the housing member 11 has a liquid supply needle 73 and a liquid recovery needle 74 as a first connected portion which is connected to the first connecting portion of the sub-tank member 31.

The liquid supply port 35 is connected to the liquid supply needle 73. The liquid supply needle 73 is a first protrusion that protrudes in the third direction D3 toward the sub-tank member 31, and the liquid supply port 35 is a first recess which is recessed in the third direction D3 so as to be away from the housing member 11. The liquid supply port 35 and the liquid supply needle 73 are each formed with a flow path inside and are configured to allow liquid to pass therethrough. These flow paths are configured to supply ink (liquid) from the sub-tank member 31 to the ejection port formed in the liquid ejection module 13. More specifically, the ink inside the sub-tank member 31 is supplied from the liquid supply port 35 to the liquid supply needle 73.

A sealing member 77 is interposed between the liquid supply port 35 and the liquid supply needle 73. The sealing member 77 is internally fitted in the liquid supply port 35 and externally fitted on the liquid supply needle 73. As described above, the liquid supply port 35 and the liquid supply needle 73 are loosely fitted to each other with the sealing member 77 interposed therebetween. The sealing member 77 seals and connects the flow paths of the liquid supply port 35 and the liquid supply needle 73 so as to prevent ink leakage.

An O-ring is preferably used as the sealing member 77. By using an O-ring, sealing can be achieved through the fitting engagement of its inner and outer peripheries, thereby allowing the sub-tank member 31 to be easily fixed to the housing member 11.

The liquid recovery port 36 is connected to the liquid recovery needle 74. The liquid recovery needle 74 is a first protrusion that protrudes in the third direction D3 toward the sub-tank member 31, and the liquid recovery port 36 is a first recess that is recessed in the third direction D3 so as to be away from the housing member 11. The liquid recovery port 36 and the liquid recovery needle 74 are each formed with a flow path inside and are configured to allow liquid to pass therethrough. These flow paths are used to recover ink (liquid) from the liquid ejection module 13 to the sub-tank member 31. More specifically, the ink in the liquid ejection module 13 is recovered to the liquid recovery port 36 via the liquid recovery needle 74.

A sealing member 77 is interposed between the liquid recovery port 36 and the liquid recovery needle 74. The sealing member 77 is internally fitted in the liquid recovery port 36 and externally fitted on the liquid recovery needle 74. In this manner, the liquid recovery port 36 and the liquid recovery needle 74 are loosely fitted to each other with the sealing member 77 interposed therebetween. The sealing member 77 seals and connects the flow paths of the liquid recovery port 36 and the liquid recovery needle 74 so as to prevent ink leakage.

In this way, the first connecting portion 81 that connects the housing member 11 and the sub-tank member 31 is composed of the liquid supply port 35, the liquid supply needle 73, and the sealing member 77, and the liquid recovery port 36, the liquid recovery needle 74, and the sealing member 77.

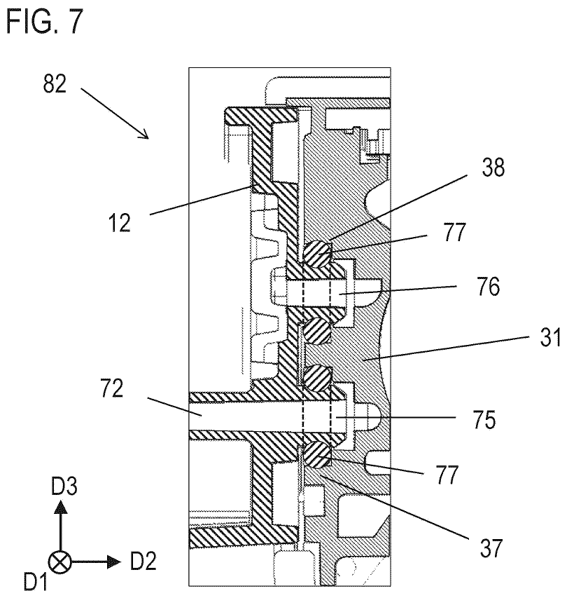

FIG. 7 is an enlarged cross-sectional view showing details of the second connecting portion 82 of the liquid ejection head 1. The sub-tank member 31 has a liquid connection port 37 and a bubble removal port 38 as a second connecting portion connected to the joint member 12. On the other hand, the joint member 12 has a liquid connection needle 75 and a bubble removal needle 76 as a second connected portion which is connected to the second connecting portion of the sub-tank member 31.

The liquid connection port 37 is connected to the liquid connection needle 75. The liquid connection needle 75 is a second protrusion that protrudes in the second direction D2 toward the sub-tank member 31, and the liquid connection port 37 is a second recess that is recessed in the second direction D2 so as to be away from the joint member 12. The liquid connection port 37 and the liquid connection needle 75 each have a flow path inside and are configured to allow liquid to pass therethrough. These flow paths supply ink (liquid) from the liquid ejection apparatus 50 to the sub-tank member 31. More specifically, ink stored in the liquid storage portion of the main body of the liquid ejection apparatus 50 is supplied from the liquid connection needle 75 to the liquid connection port 37. A flow path in communication with the flow path of the liquid connection needle 75 is formed inside the liquid connection needle 72.

The sealing member 77 is interposed between the liquid connection port 37 and the liquid connection needle 75. The sealing member 77 is internally fitted in the liquid connection port 37 and is externally fitted on the liquid connection needle 75. In this way, the liquid connection port 37 and the liquid connection needle 75 are loosely fitted to each other with the sealing member 77 interposed therebetween. The sealing member 77 seals and connects the flow paths of the liquid connection port 37 and the liquid connection needle 75 so as to prevent ink leakage.

Also in the second connecting portion 82, an O-ring is preferably used as the sealing member 77. By using an O-ring, sealing can be achieved through the fitting engagement of its inner and outer peripheries, thereby allowing the sub-tank member 31 to be easily fixed to the joint member 12. In addition, using the same sealing member 77 for each of the first connecting portion 81 and the second connecting portion 82 can lead to cost reduction.

The bubble removal port 38 is connected to the bubble removal needle 76. The bubble removal needle 76 is a second protrusion that protrudes in the second direction D2 toward the sub-tank member 31, and the bubble removal port 38 is a second recess that is recessed in the second direction D2 so as to be away from the joint member 12. The bubble removal port 38 and the bubble removal needle 76 each have a flow path formed therein and are configured to allow liquid to pass therethrough. These flow paths recover bubbles from the liquid storage portion of the sub-tank member 31. More specifically, unnecessary bubbles in the sub-tank member 31 are recovered to the bubble removal port 38 via the bubble removal needle 76.

The sealing member 77 is interposed between the bubble removal port 38 and the bubble removal needle 76. The sealing member 77 is internally fitted in the bubble removal port 38 and externally fitted on the bubble removal needle 76. In this manner, the bubble removal port 38 and the bubble removal needle 76 are loosely fitted to each other with the sealing member 77 interposed therebetween. The sealing member 77 seals and connects the flow paths of the bubble removal port 38 and the bubble removal needle 76 so as to prevent bubble leakage.

In this manner, the second connecting portion 82 that connects the joint member 12 and the sub-tank member 31 is composed of the liquid connection port 37, the liquid connection needle 75, and the sealing member 77, and the bubble removal port 38, the bubble removal needle 76, and the sealing member 77.

In the sub-tank member 31, the liquid supply port 35 and the liquid recovery port 36 are provided on a lower surface (first surface) facing the third direction D3, and the liquid connection port 37 and the bubble removal port 38 are provided on a side surface (second surface) facing the second direction D2. More specifically, the surface on which the first connecting portion is provided and the surface on which the second connecting portion is provided are non-parallel. The protruding direction of the first protrusion (the liquid supply needle 73 and the liquid recovery needle 74), which serves as the first connected portion, and the protruding direction of the second protrusion (the liquid connection needle 75 and the bubble removal needle 76), which serves as the second connected portion, intersect with each other.

While the first connecting portion 81 and the second connecting portion 82 are connected, the joint member 12 is fixed to the housing member 11 with screws, so that the sub-tank member 31 is completely held by the main body 1a of the liquid ejection head 1. In the present embodiment, the sub-tank member 31 does not have a connection portion (fixed portion) other than the first connecting portion 81 and the second connecting portion 82. Accordingly, the sub-tank member 31 is allowed to move relative to the main body 1a by an amount corresponding to the elasticity of the sealing member 77 and is not completely fixed. However, by using an O-ring as the sealing member 77, sealing performance is maintained despite such movability, so that a highly reliable liquid ejection head 1 can be provided.

As described above, the configuration of the present embodiment allows the sub-tank member 31 to be mounted to the main body 1a with a simpler structure compared to that of the comparative example. Since ink leakage can be prevented by the sealing members 77, the reliability and quality of the liquid ejection head 1 can be improved. Furthermore, since the components are fixed only by the sealing connection and not by any other means, equalization can be achieved in all directions, and as a result, greater tolerance in component dimensional accuracy is allowed, thereby improving the assembly productivity of the components.

### Modifications

Although the liquid ejection head 1 is configured to be able to circulate liquid inside in the above-described embodiment, the liquid ejection head 1 may be configured not to circulate liquid. In such a configuration, the first connecting portion 81 may include only the liquid supply port 35 and the liquid supply needle 73 without providing the liquid recovery port 36 and the liquid recovery needle 74. More specifically, in the embodiment described above, multiple first connecting portions and first connected portions as well as multiple second connecting portions and second connected portions are provided. However, alternatively, only one of each may be provided. However, in order to stably fix the sub-tank member 31 to the main body 1a, it is more preferable to provide a plurality of connecting portions and connected portions.

Also, in the above embodiments, the sub-tank member 31 has the first recess and the second recess, and the main body 1a has the first protrusion and the second protrusion, but these relationships may be reversed. For example, the sub-tank member 31 may be provided with protrusions such as various needles, and the main body 1a may be provided with recesses having openings. More specifically, one of the sub-tank member 31 and the main body 1a may be provided with a protrusion on which the sealing member 77 is externally fitted, and the other may be provided with a recess that is connected to the protrusion and in which the sealing member 77 is internally fitted.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-129031, filed on Aug. 5, 2024, which is hereby incorporated by reference herein in its entirety.

What is claimed is:

1. A liquid ejection head comprising:
a main body having a first connected portion which is configured to allow liquid to pass therethrough and a second connected portion which is configured to allow liquid to pass therethrough;
a tank stored within the main body, the tank including a liquid storage portion configured to store liquid therein, a first surface provided with a first connecting portion that is connected to the first connected portion and configured to allow liquid to pass therethrough and a second surface provided with a second connecting portion that is connected to the second connected portion and configured to allow liquid to pass therethrough, the second surface being non-parallel to the first surface; and
a plurality of sealing members interposed between the first connecting portion and the first connected portion and between the second connecting portion and the second connected portion,
wherein one of the first connecting portion and the first connected portion is a first protrusion on which the sealing member is externally fitted, and the other is a first recess in which the sealing member is internally fitted, and one of the second connecting portion and the second connected portion is a second protrusion on which the sealing member is externally fitted, and the other is a second recess in which the sealing member is internally fitted.

2. The liquid ejection head according to claim 1,
wherein the main body has a housing member provided with the first connected portion, and a joint member provided with the second connected portion and fixed to the housing member by a fixing member.

3. The liquid ejection head according to claim 2, further comprising:
a plurality of the tanks,
wherein the joint member is connected to the plurality of the tanks.

4. The liquid ejection head according to claim 1, further comprising:
an ejection port configured to eject liquid,
wherein a flow path configured to supply liquid from the tank to the ejection port is formed inside the first connecting portion and the first connected portion.

5. The liquid ejection head according to claim 1, further comprising:
a liquid ejection module having an ejection port for ejecting liquid, the liquid ejection module being connected to the main body,
wherein a flow path configured to recover liquid from the liquid ejection module to the tank is formed inside the first connecting portion and the first connected portion.

6. The liquid ejection head according to claim 5,
wherein the tank has a circulation unit configured to circulate liquid between the tank and the liquid ejection module.

7. The liquid ejection head according to claim 6,
wherein the circulation unit has a pump and pressure regulating means.

8. The liquid ejection head according to claim 1,
wherein a flow path configured to supply liquid from a liquid ejection apparatus equipped with the liquid ejection head to the tank is formed inside the second connecting portion and the second connected portion.

9. The liquid ejection head according to claim 1,
wherein a flow path configured to collect bubbles from the tank is formed inside the second connecting portion and the second connected portion.

10. The liquid ejection head according to claim 1,
wherein the sealing member is an O-ring.

11. The liquid ejection head according to claim 1,
wherein the second protrusion protrudes in a direction that intersects the first protrusion.

12. The liquid ejection head according to claim 1,
wherein the tank is provided with a plurality of the first connecting portions and the second connecting portions, and the main body is provided with a plurality of the first connected portions and the second connected portions.

13. A liquid ejection apparatus comprising:
a conveyance portion configured to convey a recording medium in a conveyance direction; and
a liquid ejection head, the liquid ejection head comprising:
a main body having a first connected portion which is configured to allow liquid to pass therethrough and a second connected portion which is configured to allow liquid to pass therethrough;
a tank stored within the main body, the tank including a liquid storage portion configured to store liquid therein, a first surface provided with a first connecting portion that is connected to the first connected portion and configured to allow liquid to pass therethrough and a second surface provided with a second connecting portion that is connected to the second connected portion and configured to allow liquid to pass therethrough, the second surface being non-parallel to the first surface; and
a plurality of sealing members interposed between the first connecting portion and the first connected portion and between the second connecting portion and the second connected portion,
wherein one of the first connecting portion and the first connected portion is a first protrusion on which the sealing member is externally fitted, and the other is a first recess in which the sealing member is internally fitted, and one of the second connecting portion and the second connected portion is a second protrusion on which the sealing member is externally fitted, and the other is a second recess in which the sealing member is internally fitted, and
wherein the liquid ejection head is configured to scan in a direction which intersects with the conveyance direction.
